(19) United States
(12) Patent Application Publication
(10) Pub. No.: US 2012/0071567 A1
(43) Pub. Date: Mar. 22, 2012

(54) FRUIT FLAVORED COCOA BUTTER BASED CONFECTION

(76) Inventors: Brian Crowley, Jersey City, NJ (US); Christopher Najmeddine, Jersey City, NJ (US)

(21) Appl. No.: 13/300,990

(22) Filed: Nov. 21, 2011

Related U.S. Application Data
(63) Continuation-in-part of application No. 13/207,395, filed on Aug. 10, 2011.
Application No. 13/207,395 is a continuation-in-part of application No. 12/930,796, filed on Jan. 18, 2011.
(60) Provisional application No. 61/295,860, filed on Jan. 18, 2010.

(51) Int. Cl. A23G 3/46; A23G 3/42; A23G 3/36; A23L 3/44; A23G 1/48; A23G 1/32; A23L 1/035; A23G 1/46; A23G 1/56; A61K 47/26; A23G 3/48; A23L 3/34

(52) U.S. Cl. 514/777; 426/660; 426/583; 426/61; 426/384; 426/654; 426/541; 426/631

(57) ABSTRACT

A fruit flavored confection made of a fruit based anhydrous component, along with sweeteners dairy and suitable confectionary fat wherein the intimate incorporation of the fruit based component and the acidic pH of the confection results in a vibrant fruit flavor profile.

This application is a continuation-in-part of U.S. patent application Ser. No. 13/207,395 entitled “Soda-Pop Flavored Cocoa Butter Based Confection” filed Aug. 10, 2011, which is a continuation-in-part of 12/930,796 entitled “Fruit Chocolate” filed Jan. 18, 2011, which claims priority to U.S. provisional application No. 61/295,860 filed Jan. 18, 2010.

### FIELD OF INVENTION

The present invention relates generally to fruit confections having a suitable confectionary fat, oil, or stearin as its principal fat constituent, a sweetener, a dairy component, and an anhydrous fruit intimately included therein wherein the fruit confection has a pH of less than about 5.75. The confection of the present invention may optionally include probiotics and prebiotics.

### BACKGROUND OF THE INVENTION

Americans love chocolate. Sales of the confection in 2009 were $17.3 billion (Packaged Facts, Market in the U.S. 2010), and it is estimated that the average American consumes about 12 pounds of chocolate per year. In fact, when the Chocolate Manufacturers Association lobbied the federal government to permit confections containing hydrogenated vegetable oil in place of cocoa butter to be sold as “chocolate,” the public outcry forced the FDA to re-iterate that “Cacao fat, as one of the signature characteristics of the product, will remain a principal component of standardized chocolate” “FDA's Standards for High Quality Foods”. Food and Drug Administration. http://www.fda.gov/consumer/updates/foodstandards061807.html.

Americans' love of chocolate is two-fold. First, the flavor of chocolate is preferred by the 66% of the populace with vanilla and fruit flavors a distant second and third. Second, the mouth feel, the chemical and physical relationship of food with the individual's mouth, is unique. The buttery smooth mouth feel of chocolate leaves the consumer feeling fulfilled, happy and/or relaxed. The importance of mouth feel to the consumer is highlighted by the above-noted response to the Chocolate Manufacturers Association's efforts to replace cocoa butter.

Fruit and chocolate has always been a popular combination for confections. The use of real fruit, fresh or dried, has been featured in chocolate confections such as chocolate covered strawberries, chocolate covered bananas, and chocolate covered raisins sold as Rasinetes™, (Nestle, S.A.). In each of these cases, the fruits retain a distinct identity from the chocolate and merely act as a compliment to the chocolate as opposed to being part and parcel of the chocolate. Further, because of the moisture content of the fruit it was not possible to truly incorporate it into a cocoa butter based confection.

Recently, greater efforts have been made to intimately incorporate fruit and fruit components into chocolates. First, an effort has been made to incorporate fruits within chocolates in order to rehabilitate chocolate's perception as a healthy indulgence. For example, patent publication GB2468692 discloses the incorporation of fruit powders within a chocolate confection largely to increase the perceived and actual nutritional value of the chocolate. Further, WO2006/130698 discloses the use of fruit purees to render amorphous sweeteners suitable for use within chocolate confections. However, these applications incorporate the fruit as a sweetening aid as opposed to a flavoring or coloring component and therefore the hope is to maintain the taste and mouth feel of the chocolate despite the inclusion of fruit.

Second, confectioners have attempted to intimately incorporate the taste of fruits into chocolates through the incorporation of fruit powders. Patent publications US2009/0304867, WO2009/027039, R0121666, KR100932658, U.S. Pat. No. 5,158,800, and US2008/0299275 disclose the incorporation of fruit powders within a chocolate confection to impart a fruit flavor and or appearance to the chocolate. However, in practice, the fruit particles merely become coated by the vegetable fat impairing the fruit flavor impression provided by the chocolates. Further, it has been found that the fruit flavor impressions of chocolates manufactured in this manner are flat and lack the vibrant qualities of the fruits they are derived from, the source fruit. Without wishing to be bound to a particular theory, inventors believe this is due in part to the dehydration of the fruit powders and therefore their need to rehydrate within the consumers mouth before the fruit flavor comes into bloom.

Thus, there remains a need for a fruit flavored chocolate or chocolate-like confection that possesses the vibrant fruit profile of the source fruit.

The foregoing discussion is presented solely to provide a better understanding of the nature of the problems confronting the art and should not be construed in any way as an admission as to prior art nor should the citation of any reference herein be construed as an admission that such reference constitutes “prior art” to the instant application.

### SUMMARY OF THE INVENTION

The present invention is directed to a melt-away fruit-flavored confection prepared in the absence of cocoa solids having a pH of less than 5.75 made of an anhydrous component of at least one fruit wherein the fruit of the anhydrous component has a pH in its natural ripened state; a sweetener; a dairy product; and a suitable confectionary fat.

In a further embodiment of the invention, the confectionary product has a pH of no less than about 3. In yet a further embodiment, the pH of the confectionary product is within ±1.5 pH units of the pH of one of the fruits contained within the anhydrous component in its natural ripened state, more preferably within ±0.75 of the pH of one of the fruits contained within the anhydrous component in its natural ripened state, and most preferably the pH of the confectionary product is the same as the pH of one of the fruits contained within the anhydrous component in its natural ripened state.

In another embodiment, the fruit of the anhydrous component is comprised of whole fruit, juiced fruit, fruit-based acids or flavorings. The fruit based component may be of any of the known culinary fruits including but not limited to apple, pear, grape, drupe fruit, citrus fruit, berry, papaya, cactus fruit, melon, pumpkin, avocado, guava, cherimoya, pomegranate, banana, kiwi fruit, palm fruit, persimmon, tamarind, mango, pineapple, peppers, or mixtures thereof in further embodiments of the invention. In a further embodiment, the anhydrous fruit component is rendered so through freeze-drying. In certain embodiments the anhydrous fruit component may also incorporate an anti-caking agent, such as a saccharide or sugar alcohol, during the freeze drying process. The anti-caking agent may be a low-DE maltodextrin. Also, the particle size of the anhydrous fruit component may have a D⁹⁰ less than or equal to about 50 μm, preferably about 15 μm, and most preferably about 2 μm. The anhydrous fruit component may also comprise less than about 40% by weight of the confection.

In a further embodiment, fruit acids or flavorings may be comprised of natural or replicated nature identical compounds thereof. Further, the natural flavors may be comprised of fruit oils or fruit essences.

In a further embodiment, the confectionary product is further comprised of an artificial flavoring.

Additionally, another embodiment of the invention is directed to a melt-away fruit-flavored confection in which the dairy product is cream, milkfat, butter, milk, concentrated milk, evaporated milk, sweetened condensed milk, dried milk, skim milk, concentrated skim milk, evaporated skim milk, sweetened condensed skim milk, nonfat dry milk, sweet cream buttermilk, concentrated buttermilk, dried buttermilk, malted milk, cultured milk (yogurt, kefir, etc.), dried cultured milk, whey, whey products, or combinations thereof.

The suitable confectionary fat of the confectionary product of the current invention may be a vegetable derived fat, oil, stearin, or combination thereof in yet another embodiment of this invention. The vegetable derived fat may be cocoa butter, shea butter; mowra butter; kokum butter; illipe butter; Borneo tallow, or combinations thereof. The vegetable derived oil may be partially hydrogenated palm kernel oil, partially hydrogenated coconut oil, partially hydrogenated palm oil; fractionated palm kernel oil, fractionated palm oil, fractionated coconut oil, fractionated corn oil, fractionated peanut oil, fractionated soy oil, fractionated cottonseed oil, fractionated sunflower oil, fractionated safflower oil, or combinations thereof. In a preferred embodiment, the vegetable derived fat is cocoa butter.

In yet another embodiment of the invention, the sweetener in the confection is a nutritive sweetener or alternatively is a non-nutritive sweetener.

In a further embodiment, the confectionary product may contain cryoprotected probiotics. The probiotics may be selected from probiotics such as Lactobacilli, Bifidobacteria, Streptococci, Pediococci, Leuconostoc, propionic and acetic bacteria. Preferably, the probiotics are cryoprotected through freeze-drying in the presence of skim milk, sucrose, lactose or polyols to provide a shelf life and at least about 100 million colony forming units of the cryoprotected probiotic per gram of the confectionary product remain viable throughout the shelf life of the confectionary product.

In additional embodiments, the melt-away fruit-flavored confection of the current invention may include further components such as emulsifying agents, preservatives, essential nutrients, minerals, biogenic amines, herbal extracts, stimulants, raw cocoa powder, dutched cocoa powder, and/or chocolate liquor. In those embodiments in which emulsifying agents are present, the total amount of the emulsifying agent preferably does not exceed about 2 percent by weight of the fruit-chocolate. Further, the addition of essential nutrients, minerals, biogenic amines, herbal extracts, and/or stimulants may provide an additional embodiment of the invention in which the confection provides an energy enhancement to an individual consuming the confection. Further embodiments, may also include essential nutrients, anhydrous medicinal formulations, naturally derived metabolic compounds, or federally approved pharmaceuticals.

Further embodiments of the confectionary product may include botanical elements, saccharides, or sugar alcohols. Suitable botanical elements may include anhydrous plant-based culinary additives derived from vanilla bean, spice extracts, herbal extracts, ground herbs, ground spices, root extracts, powdered stevia extract, green tea powder, black tea powder, bee pollen, rhubarb, powdered soymilk, chlorophyll, freeze dried beet juice, malted cereal extracts, freeze dried wine, coffee, kola, yerba mate, guarana extractives, freeze dried grass and sprout extracts, ground nuts or seeds, nut or seed extracts, powdered flowers, floral essences, essential oils and/or mixtures thereof. Saccharides including those derived from crystallized honey, turbinado sugar, dried agave cactus syrup, maple syrup crystals, dried brown rice syrup, corn sugars, caramelized sugar, sorghum syrup crystals, birch syrup crystals, dried barley malt syrup, palm sugar, arenga sugar, coconut sugar; sucralose; or any saccharide, oligosaccharide, and polysachaccharide present in food or essential in food technology may be added.

In yet another embodiment of the current invention, the confectionary product may incorporate one or more inclusions. The inclusion may be gasified candy, encapsulated liquid(s), cookies, wafers, nougat, caramel, carob, pralines, crisped or puffed grains, taffy, toffee, pretzels, nuts, seeds, dried fruit, and/or combinations thereof. In a further embodiment wherein the inclusion is an encapsulated liquid, the encapsulated liquid may be a flavor enhanced lipophilic core inside a gelatin or alginate shell.

The current invention also relates to a method of manufacturing the inventive melt-away fruit-flavored confection by freeze drying a fruit having a pH in its natural ripened state in the presence of a saccharide or sugar alcohol; and adjusting the pH of the confectionary product to within about ±1.5 ph units of the fruits pH through the addition of an acid. Preferably, the saccharide used in the method is a low-DE maltodextrin, and the acids are fruit based acids.

### DESCRIPTION OF THE DRAWINGS

FIG. 1 depicts a process for manufacturing a fruit confection.

### DETAILED DESCRIPTION

All terms used herein are intended to have their ordinary meaning unless otherwise provided.

As used in the description of the invention and examples, the singular forms “a”, “an”, and “the” include both singular and plural referents unless the context clearly dictates otherwise. By way of example, “a fruit” refers to one or more than one fruit. The terms “comprising”, “comprises” and “comprised of” as used herein are synonymous with “including”, “includes” or “containing”, “contains”, and are inclusive or open-ended and do not exclude additional, non-recited members, elements or method steps.

As used herein, the term “consisting essentially of” is intended to limit the invention to the specified materials or steps and those that do not materially affect the basic and novel characteristics of the claimed invention, as understood from a reading of this specification.

The recitation of numerical ranges by endpoints includes all numbers and fractions subsumed within that range, as well as the recited endpoints.

The term “about” as used herein when referring to a measurable value such as a parameter, an amount, a temporal duration, and the like, is meant to encompass variations of +/−20% or less, preferably +/−10% or less, more preferably +/−5% or less, even more preferably +/−1% or less, and still more preferably +/−0.1% or less from the specified value, insofar such variations are appropriate to perform in the disclosed invention.

All percentages are by weight based on the total weight of the composition, unless otherwise indicated.

The present inventors have discovered that if a powdered anhydrous fruit is intimately incorporated into the lipid constituent of a fat based confection, similar to white chocolate, and the pH of the confection is maintained below 5.75 pH, preferably within a range±1.0 pH, more preferably within a range±0.5 pH, though most preferably equal to, the pH of the source fruit, the fruit or fruits from which the anhydrous fruit is derived, in its naturally ripened state, then a vibrant fruit flavor profile largely approximating the flavor of the actual fruit from which the anhydrous product was obtained will be appreciated. Featured prominently in the recipe are an anhydrous fruit, a suitable confectionary fat, a dairy product, a sweetener, and, where necessary, a suitable acid to maintain the pH of the overall confection below 5.75 pH. The combination of and the process by which such ingredients are prepared and combined are that which makes this product unique.

Confection

In a primary embodiment of the inventive fat based confection, the confection has an anhydrous fruit based component, a dairy product, a sweetener, and a suitable confectionary fat.

The fruit based component is defined as being derived from a fruit, which technically is the developed ovary of a seed plant.

Fruits from which the anhydrous fruit based component may be derived may include, but are not limited to, pome fruits: Apple and/or crabapple (Malus) and various species thereof, Chokebarry (Aronia), Hawthorn (Crataegus and Rhaphiolepsis), Loquat (Eriobotrya japonica), Medlar (Mespilus germanica), Pear (Pyrus) including European and Asian species thereof; Quince (Cydonia oblonga and Chaenomeles), Rose Hip (Rosa), Rowan (Sorbus), Sorb or sorb apple (Sorbus domestica), saskatoon (Amelanchier); and Shipova (Sorbopyrus auricularis); Drupes of genus Prunus: Apricot (Prunus armeniaca or Armeniaca vulgaris), cherry (sweet, black, sour and wild species (Prunus avium Prunus serotina, Prunus cerasus, and others); Chokecherry (Prunus virginiana), Greengage, Peach (normal, white, and nectarine (Prunus persica)), Plum (domestic and wild varieties as well as dried plums (prunes)), as well as hybrids thereof (pluot, apricum, peacotum, etc.); Lychee (Litchi chinensis); Mangoes (Mangifera indica); Avocado (Persea americana and various cultivars thereof); berries: genus Rubus—Blackberry (all edible species and various hybrids such as dewberry, boysenberry, oliallieberry, tayberry, etc.), Cloudberry (Rubus chamaemorus), Loganberry (Rubus loganobaccus), raspberry (all edible species), Salmonberry (Rubus spectabilis), Thimbleberry (Rubus parviflorus), and Wineberry (Rubus phoenicolasius); genus Ericaceae—Bearberry (Arctostaphylos spp.), Bilberry or whortleberry (Vaccinium spp.), Blueberry (Vaccinium spp.), Crowberry (Empetrum spp.), Cranberry (Vaccinium spp.), Falberry (Vaccinium spp.), Huckleberry (Vaccinium spp.), Lingonberry (Vaccinium vitis-idaea), and Strawberry (Fragaria); others—Currant (Ribes spp.; Grossulariaceae) (red, black, and white types), Elderberry (Sambucus; Caprifoliaceae), Gooseberry (Ribes spp.; Grossulariaceae), Hackberry (Celtis spp.; Cannabaceae), Honeysuckle (edible berries of some species (honeyberries)), Mulberry (Morus spp.; Moraceae) including: Red Mulberry (Morus rubra) and White Mulberry (Morus alba), Mayapple (Podophyllum spp.; Berberidaceae), Nannyberry or sheepberry (Viburnum spp.; Caprifoliaceae), Oregon grape (Mahonia aquifolium; Berberidaceae), Sea-buckthorn (Hippophae rhamnoides; Elaeagnaceae), Ugniberry (Ugni molinae; Myrtaceae), and Wolfberry (Lycium barbarum, Lycium spp.; Solanaceae); Citrus (Rutaceae): Key Lime, Omani Lime (Citrus aurantifolia), Pomelo (pummelo, shaddock) (Citrus maxima), Citron (Citrus medica), Mandarin orange (Citrus reticulata), Trifoliate Orange (Citrus trifoliata), Australian limes: Finger lime (Citrus australasica), Australian Round Lime (Citrus australis), Desert Lime (Citrus glauca), Kumquats, Papedas, including limau kadangsa, limaus kedut kera (Citrus halimii), Indian Wild orange (Citrus indica), Citrus macroptera, Khasi Papeda (Citrus latipes) as well as various hybrids and cultivars including, but not limited to, Citrus maxima-based: Amanatsu, natsumikan, Cam sành, Grapefruit, Imperial Lemon, Kinnow, Kiyomi, Lemon (Citrus Limon), Minneola Tangelo, Orangelo, Chironja, Oroblanco, Sweetie, Sweet Orange, Tangelo, Tangor, Ugli, etc.; Citrus medica-based: Buddha's Hand, Diamante citron, Florentine citron, Greek citron, Balady citron, Corsican citron, Moroccan citron, Etrog, Fernandina, Ponderosa Lemon, Yemenite citron, etc.; Citrus reticulata-based: Bergamot Orange, Bitter Orange, Seville Orange, Blood Orange, Calamondin, Calamansi, Cam sành, Chinotto, ChungGyun, Clementine, Cleopatra Mandarin, Dekopon, Daidai, Hermandina, Kinnow, Wilking, Kiyomi, Laraha, Mediterranean Mandarin, Willow Leaf, Meyer Lemon, Valley Lemon, Michal Mandarin, Mikan, Satsuma, Nova Mandarin, Clemenvilla, Orangelo, Chironja, Ponkan, Rangpur, Lemanderin, Mandarin Lime, Tangerine, Yuzu, etc.; or Other: Alemow, Colo, Djeruk limau, Gajanimma, Carabao Lime, Ichang Lemon, Ichang Papeda, Iyokan, anadomikan, Kabosu, Kaffir Lime, makrut, Limetta, Sweet Lemon, Sweet Lime, mosambi, Palestine Sweet Lime, Persian lime, Tahiti Lime, Pompia, Rough Lemon, Sakurajima komikan orange, Shekwasha, Hirami Lemon, Taiwan Tangerine, Sudachi, Sunki, Suenkat, Tachibana Orange, Volkamer Lemon, etc.; temperate fruits: Boquila (Boquila trifoliata; Lardizabalaceae), Goumi (Elaeagnus multiflora; Elaeocarpaceae), Keule (Gomortega keule; Gomortegaceae), Lardizabala (Lardizabala biternata; Lardizabalaceae), Maqui (Aristotelia chilensis; Elaeocarpaceae), American Pawpaw (Asimina triloba; Annonaceae), or Peumo (Cryptocarya alba matthew clark; Lauraceae); subtropical fruits; grapes (Vitis) and various species thereof including, but not limited to, Vitis labrusca, Vitis riparia, Vitis rotundifolia, Vitis amurensis, or Vitis vinifera and various cultivars thereof; papaya (Carica papaya), cactus fruits (pitaya (sweet pitaya (Hylocereus and various edible species thereof) and sour pitaya (Stenocereus and various edible species thereof), prickly pear (Opunita and various edible species thereof)), melons (Citrillus and Cucumis and various species thereof such as honeydew (Cucumis melo inodorus), cantaloupe (C. melo reticulatus), canary (C. melo (Indorus group)), watermelon (Citrullus lanatus), and hybrids thereof such as galia (cataloupe-honeydew cross)), Pumpkin (Cucurbita pepo, Cucurbita mixta, Cucurbita maxima, and Cucurbita moschata), Guava (Psidium and various species thereof such as P. guajava), Cherimoya (Annona cherimola), Pomegranate (Punica granatum), Banana (Musa acuminata, Musa balbisiana or hybrids Musa acuminata×balbisiana), Kiwi fruits (Actinidia deliciosa and hybrids between this and other species in the genus Actinidia), Palm fruits, Passion fruit (Passiflora and various species and cultivars thereof such as P. edulis, P. ligularis), Persimmon (Ebenaceae diospyros and various cultivars thereof), Tamarind (Tamarindus indica), Pineapples (Ananas comosus), Starfruit (Averrhoa carambola), Fig (Ficus carica); Miracle Fruit (Synsepalum dulcificum) Peppers (Capsicum including various cultivars such as jalepenos (Capsicum annuum cultivar), habeneros, etc), varieties, cultivars, and hybrids thereof as well.

The fruit based component may be derived from the edible fleshy part of the fruit such as the pericarp in berries or drupes, the fruit cortex or torus of pomes, the fruit and zest of citrus fruits, the fruit's juice, and/or combinations thereof. In most embodiments it will be desirable to eliminate the inedible, less edible, or poisonous parts of the fruit for example the seeds and core of an apple or the seeds and rind of an orange, as well as any poisonous parts of the fruit etc. prior to rendering the fruit component anhydrous. For this purpose, seedless varieties for some fruits, i.e., seedless grapes (such as the Thompson Seedless, Russian Seedless, and Black Monukka varietals), seedless watermelons, etc., may be preferred within certain embodiments of the current invention. Furthermore, the use of fruit purees having been prepared in an oxidation free environment may be used; however jams are less desirable in embodiments of the current invention and are preferably excluded from use as the basis for the fruit component.

The fruit based component is dehydrated, and more preferably rendered substantially anhydrous (about 97.5% or more free of water, preferably about 98% or more free of water, more preferably 99% free of water, and most preferably more than 99.5% free of water), and most preferably rendered completely anhydrous, (100% free of water). Dehydration of the fruit component may be accomplished through various means known in the art including, but not limited to, freeze-drying, heating, spray drying, or combination thereof. Preferably, the fruit based components are rendered anhydrous through the use of freeze drying.

It should first be noted that the freeze-dried components are those in which the water content has been sublimated. The freezing step is one in which the component to be dried is taken to a temperature and pressure lower than the triple point at which the solid and liquid phases of the water contained therein can exist. By increasing the temperature above 0° C., while keeping the pressure below 0.06 atmospheres (ATM), the water inside the material sublimates directly from a solid to a gas, bypassing the liquid phase, and thus drying the material leaving behind the water soluble flavor constituents.

The freeze-drying is carried out under vacuum. A primary drying phase may remove as much as 98% of water by sublimation; an additional drying phase is utilized to sublimate the remaining approximately 2% of water. Typically, once the component has been freeze-dried, the vacuum is broken with an inert gas such as nitrogen, and the freeze-dried product is further treated for purposes of the present invention. Preferably the freeze drying phase is through a process known as Active Freeze Drying, utilizing a single vessel and a continuous forced motion during the freezing and sublimation phases producing a free flowing powdered product. Such a method of freeze drying significantly reduces the drying time providing for increased volumes of powdered anhydrous fruit particles, as well as producing a product that requires a shortened milling phase for further reduction of particle size, thus providing for minimal heat degradation of the fruit component.

Low-Dextrose Equivalent (DE) Maltodextrins have a very low/non-hygroscopicity, in that they do not retain moisture very well, if at all, in conditions where evaporation can occur. Therefore, according to the present invention, low-DE maltodextrins are incorporated into the juiced fruit component prior to the freeze drying to aid in lowering the hygroscopicity of the fruit juice's high water-retaining fructose content, act as an anti-caking agent and provide for a more free flowing powder. Preferably the incorporation of maltodextrin is in percentages equal to 5-25% of the sugar content of the juice.

Subsequent to the dehydration process the resulting product is mechanically processed, i.e., milled, crushed, pulverized, etc., to reduce the dehydrated fruit based component to a powder. Preferably, the size of the particles within the powder are less than or equal to about 50 μm, preferable less than or equal to about 40 μm, more preferably less than or equal to about 30 μm, and most preferably less than or equal to about 15 μm. Alternatively, the particles of the powder have a D⁵⁰, the diameter below which 50% of the volume of all particles of a powder is found, is less than or equal to about 50 μm, preferable less than or equal to about 40 μm, more preferably less than or equal to about 30 μm, and most preferably less than or equal to about 15 μm. More preferably the particles within the powder exhibit a D⁹⁰, the diameter below which 90% of the volume of all particles of a powder is found, of less than or equal to about 50 μm, preferable less than or equal to about 40 μm, more preferably less than or equal to about 30 μm, and most preferably less than or equal to about 15 μm.

Further, the freeze-dried or otherwise dehydrated fruit based component may be milled in the presence of a saccharide, including, but not limited to, sucrose, and maltodextrin, or polyols/sugar alcohols, hydrogenated forms of carbohydrates including, but not limited to, erythritol, mannitol, isomalt, or maltitol. The included saccharide and/or sugar alcohol may act as a desiccant, aiding in preventing the rehydration of the fruit based component, as well as a milling aid. The saccharide and/or sugar alcohols used for this purpose preferably have a lower hygroscopicity than fructose.

The percentage of the product comprised of the fruit based component is dependent on each fruits' individual flavor intensity, but should not exceed about 35% by weight of the resulting confection, preferably not more than 30% by weight of the resulting confection, and most preferably not more than about 25% by weight of the resulting confection.

The confections of the current invention include sweeteners—carbohydrate, nutritive, non-nutritive, crystalline and/or amorphous (examples of suitable amorphous sweeteners are provided within PCT/US2006/021130 entitled “Chocolate Products Containing Amorphous Solids And Methods of Producing Same” published as WO 2006/130698, and hereby incorporated by reference in its entirety) sweeteners. Preferably, the confection includes nutritive sweeteners including, but not limited to, sucrose, and more preferably includes crystalline nutritive sweeteners. Preferably no greater than about 55% by weight of the above-noted sweeteners are used with the confections of the current invention. Depending upon the natural sweetness of the fruit derived component of the current invention, it may act as a substitute for a portion of or the entirety of the sweetener within the confection of the current invention. In such instances the amount of the fruit derived component may exceed about 35% by weight of the resulting confection given that it is also providing the sweetener for the confection, but the amount of the fruit derived component should not exceed about 55% by weight of the resulting confection.

The confections of the current invention also incorporate the dairy products, including, but not limited to, cream, milkfat, butter, milk, concentrated milk, evaporated milk, sweetened condensed milk, dried milk, skim milk, concentrated skim milk, evaporated skim milk, sweetened condensed skim milk, nonfat dry milk, sweet cream buttermilk, concentrated buttermilk, dried buttermilk, malted milk, cultured milk (yogurt, Kefir, etc.), dried cultured milk, whey, whey products, or combinations thereof. The dairy product solids may be present in an amount equal to or greater than about 5% by weight of the resulting confection, preferably it is greater than or equal to about 10% by weight of the resulting confection, and most preferably greater than or equal to about 14% by weight of the resulting confection. Additionally, it is preferred that milk fats comprise equal to or greater than 3.5% by weight of the resulting confection.

Preferably, the sweeteners and dairy products are rendered anhydrous, preferably completely anhydrous, and reduced to a powder using known methods. Preferably, the size of the particles within the powder are less than or equal to about 50 μm, preferable less than or equal to about 40 μm, more preferably less than or equal to about 30 μm, and most preferably less than or equal to about 15 μm. Alternatively, the particles of the powder have a D⁵⁰ less than or equal to about 50 μm, preferable less than or equal to about 40 μm, more preferably less than or equal to about 30 μm, and most preferably less than or equal to about 15 μm. More preferably the particles within the powder exhibit a D⁹⁰ of less than or equal to about 50 μm, preferable less than or equal to about 40 μm, more preferably less than or equal to about 30 μm, and most preferably less than or equal to about 15 μm.

The fruit confection of the current invention includes suitable confectionary fats, i.e. fats, oils, stearins, or combination thereof that have a melting point/range of around 34-38° C. (93-100° F.), that render the chocolate or chocolate-like confection solid at room temperature yet readily meltable within a person's mouth. Such suitable confectionary fats include, but are not limited to, cocoa butter, natural or synthetic cocoa butter alternatives, and/or combinations thereof. Cocoa butter alternatives include, but are not limited to, cocoa butter substitutes, cocoa butter replacers, or cocoa butter equivalents. Cocoa butter substitutes have similar physical properties, but not chemical composition, to cocoa butter. Cocoa butter substitutes tend to be lauric fats or oils which include, but are not limited to, fats derived from palm kernel oil and/or coconut oil. Additional cocoa butter substitutes are disclosed within U.S. Pat. Nos. 5,387,429; 4,157,405; 4,348,423; 4,601,790; 5,188,858; 3,537,865, 3,012,891, 3,012,890; 2,975,062; 4,822,875; 3,856,831; 5,275,835; 2,975,061; 2,993,063; 3,093,480; 6,210,739; 5,932,275; 4,072,766; and 4,839,192; hereby incorporated by reference in their entirety. Cocoa butter replacers include non-lauric high trans-fats that include, but are not limited to, fractionated or partially hydrogenated soybean oil, rapeseed oil, sunflower oil, palm oil, cotton seed oil, or other similar fats or oils. Additional cocoa butter replacers are disclosed within U.S. Pat. Nos. 5,405,639 and 6,229,033, hereby incorporated by reference in their entirety. Cocoa butter equivalents have similar physical properties as well as chemical composition to cocoa butter and can be used interchangeably with cocoa butter. These products are typically made by formulating high POP palm mid fraction with other exotic fats such as illipe fat, shea fat, mowra butter, kokum butter, Borneo tallow, sal fat, mango fat, and/or other similar fats or oils. Cocoa butter equivalents are also disclosed within U.S. Pat. Nos. 5,210,241 and 5,171,604, hereby incorporated by reference in their entirety. Additionally, vegetable derived fats, oils, or stearins that may be suitable for use as confectionary fats of the current invention include, but are not limited to, oils and fats such as partially hydrogenated palm kernel oil, partially hydrogenated coconut oil, partially hydrogenated palm oil; fractionated palm kernel oil, fractionated palm oil, fractionated coconut oil, fractionated corn oil, fractionated peanut oil, fractionated soy oil, fractionated cottonseed oil, fractionated sunflower oil, fractionated safflower oil, shea butter; mowra butter; kokum butter; illipe butter; Borneo tallow, or combinations thereof. Preferably, the confection of the current invention is manufactured using cocoa butter as the suitable confectionary fat, and most preferably, cocoa butter is the sole confectionary fat used within the confection.

In order to further the objective of this invention—a confection that possesses a vibrant fruit flavor—the suitable confectionary fat, cocoa butter, or cocoa butter alternatives may be deodorized to reduce their inherent olfactory or flavoring qualities and thereby enhance the flavoring of the fruit based component within the resulting confection. This may be done using known deodorizing processes within the art including those disclosed within U.S. Pat. No. 4,601,790, hereby incorporated by reference in its entirety.

The suitable confectionary fat is present within the current confection from about 7% to about 50% by weight of the overall confection, preferably about 10% to about 45% by weight of the confection; and more preferably about 20% to about 35% by weight of the confection. Alternatively, the suitable confectionary fat is present in amount of about 20% or greater by weight of the overall confection. Most preferably, cocoa butter is used within the amounts and ranges disclosed within 21 C.F.R.—Food and Drugs, Chapter 1—Food and Drug Administration, Department of Health and Human Services, Part 163—Cacao Products, The Cocoa and Chocolate Products (England) Regulations, 2003 No. 1659, IBN0110466705 and 2009 revision thereof and/or Directive 2000/36/EC relating to cocoa and chocolate products intended for human consumption, OJ 2000 L 197, hereby incorporated by reference in their entirety, and in particular the amounts and ranges suitable for white chocolate.

Further, as noted above, confections that incorporate anhydrous fruit powders as the sole fruit flavoring have flat, single dimensional flavor profiles. A combination of additional fruit flavorings—such as fruit oils and/or essences, and/or natural, organic, nature-identical or, though less preferably, artificial flavor compounds—have been shown to better approximate the flavor of the fully ripened source fruit. Such flavorings are added to the product in quantities that allow for optimum palatability.

In particular, the confections of the current invention are acidic in nature and thereby maintain the vibrant flavor profile of the source fruit, a flavor profile not found in fruit chocolates within the art. In addition, it has been found that the salivation response increases with the further deviation from neutral pH (7.0). Accordingly, the higher acid levels of the current invention provide for an increased salivation response, which allows for a further enhancement in the flavor profile as the increased salivation will hydrate the anhydrous fruit based component more quickly thus providing for a self-propagating salivary and taste response to the confection.

The confections of the current invention have a pH of less than about 7, preferably less than about 6, and more preferably less than about 5.75, and more preferably less than about 5.65, and most preferably less than about 5.5. In further embodiments, the pH of the confection is no less than about 3. The confection preferably has a pH in the range of about 3 to 5.75, more preferably about 3 to 5.65, and most preferably about 3 to 5.5. In another embodiment of the current invention, the pH of the confection is within about ±0.1 to 1.5 pH units, preferably it is within about ±1 pH unit, more preferably within about +0.5 pH units, more preferably about ±0.25 pH units, and more preferably about ±0.10 pH units, and most preferably the same pH as that of the source fruit in its ripened state. The pHs of typical fruits are listed below in Table 1.

TABLE 1
Fruit pH

| Fruit | pH |
|---|---|
| Apples | 3.3-3.9 |
| Apricots | 3.3-4.8 |
| Bananas | 4.5-5.2 |
| Blackberries | 3.9-4.5 |
| Blueberries | 3.1-3.4 |
| Cherries | 3.2-4.5 |
| Cider | 2.9-3.3 |
| Cranberry juice | 2.3-2.5 |
| Gooseberries | 2.8-3.1 |
| Grapefruit | 3.0-3.7 |
| Grapes | 3.5-4.5 |
| Lemon juice | 2.0-2.6 |
| Lime juice | 2.0-2.4 |
| Mangos | 3.4-4.8 |
| Nectarines | 3.9-4.2 |
| Oranges | 3.0-4.0 |
| Peaches | 3.4-4.1 |
| Pears | 3.6-4.0 |
| Plums | 2.8-3.0 |
| Pumpkin | 4.8-5.2 |
| Raspberries | 3.2-3.6 |
| Strawberries | 3.0-3.9 |
| Watermelon | 5.2-5.6 |

Because of the dilution of the acidity levels of the fruit component in the intimate incorporation—due to its inclusion into a product whose pH is higher than those of the fruit component—the addition of acids must be at levels that are sufficient to render the pH of the final product within the ranges of pH provided above. In particular, fruit based acids, such as malic, citric, ascorbic and tartaric, are preferred and in some embodiments it may be preferred to use the fruit acid found within the source fruit, for example malic acid if the source fruit is an apple. However, it is contemplated that other acids suitable for use within food, especially confections, may be substituted for the fruit acids such as for purposes of upscaling the production of the confections of the current invention, reducing the cost of manufacturing, achieving a particular flavor profile, or enhancing the preservation of the confection.

A pH probe such as the pH Spear (Eutech PHSPEAR/01×366920/Oakton 35634-40, Eutech Instruments/Oakton, Vernon Hills, Ill.) may be used to measure the pH of the overall confection. A modified version of the procedure detailed within Title 21, Chapter 1; Part 114.90(6) (iii) of FDA regulations may be used to measure the pH of the confection. Specifically, the confection is diluted with deionized water to a 4:1 (confection:water) ratio and is then heated to a temperature above 100° F. The mixture is then agitated/blended until it forms a homogenous solution. The solution is then cooled until 77° F. (25° C.) and the pH probe is then used to determine the pH of the confection.

For purposes of manufacturing the confections of the current invention the flavoring components, oils, essences, acids, etc. may be added to the fruit based component prior to dehydration/freeze-drying, to the overall confection prior to, during, and/or after conching, and/or some combination thereof. It is preferable that the flavoring components be added at times that will maintain their flavoring effect, i.e., it may be preferable to add fruit essences to the confection after conching as the heat and pressure of conching may breakdown any volatile components within the essence. In another embodiment, the final confection may be dusted/coated with the fruit flavoring components such as oil, essence, fruit acids and/or salts of fruit acids and optionally combined with whatever additives may be needed to protect against the oxidation and/or hydration of these components. In these embodiments, the external dusting may provide a way of eliciting a prompt salivary response to the confection.

Additionally included, though undetectable to the taste, are a beneficial amount of colony forming units (CFUs) of probiotics, i.e., microorganisms that confer a health benefit to the host when administered in adequate amounts, see, for example, Charalampopoulos, D. and Rastall, R., Prebiotics and Probiotics Science and Technology, Springer 2009; Lee, Y. and Salminen, S., Handbook of Probiotics and Prebiotics, John Wiley & Sons 2009; “Institute of Food Technologists Scientific Status Summary-Probiotics” in Food Technology, Vol. 53, No. 11, November, 1999; “The Probiotic Solution” in Nutrition Science News, Vol. 5, No. 12, December, 2000; “Probiotics” in Nutraceuticals World, April, 2000; “Examining the Prebiotic and Probiotic Market” in Nutraceuticals World, April, 2000; and “The Good Bugs” in The Boston Globe, Nov. 21, 2000, page E01. Probiotics useful in this application may include any microorganism that provides a health benefit to the host when sufficient CFU's are ingested, and preferably the probiotic strains are capable of being dried and/or frozen while maintaining their viability. In particular, probiotics useful in the current fruit flavored chocolates may include, but are not limited to, the following Lactobacillus spp.: acidophilus, amylovorus, brevis, bulgaricus, plantarum, paracasei, pentosaceus, rhamnosus, fermentum, caucasicus, helveticus, lactis, reuteri, casei, delbrueckii, gaseri, Johnsonii, or salivarius; Bifidobacteria spp.: adolescentis, animalis, bifidum, breve, infantis, lactis, or longum; Streptococcus spp.: thermophilus, cremoris, faecium, infantis, or macedonicus; Enterococcus faecium, Sacchromyces boulardii; Bacillus spp.: subtilis, pumilus, or lichenformis; Propionibacteria; Lactococcus spp.: lactis or raffinolactis; Leuconostoc pseudomesenteroides; Debaromyces hansenii, Mucor fragilis; Yarrowia lipolytica; Galactomyces geotrichum; Escherichia: Coli Nissle 1917; Clostridium, as well as species or subspecies thereof. The probiotics may be present in their natural form, i.e., present in the same manner as the probiotic would be in nature, or its processed form, i.e., purified or genetically modified strains thereof.

As noted above, the probiotics are preferably dried or frozen in order to incorporate them into the confections of current invention while maintaining their stability and viability throughout the manufacturing, distribution, sale, and consumption of the fruit confection. The measure of a probiotic's viability is a Colony Forming Unit, a measure of viable bacteria cells per gram (CFU/g). The probiotics should be present at the time of packaging the confection of the current invention, more preferably at the confection's time of consumption, and most preferably till the confections expiration date (@ 6-12 months from manufacturing), at a CFU/g sufficient to confer benefits upon the consumer, i.e. host. In particular, the probiotic should be present at greater than or equal to about 100,000 CFU/g. Preferably, the probiotic is present at greater than or equal to about 1,000,000 CFU/g; more preferably, the probiotic is present at greater than or equal to about 5,000,000 CFU/g, still more preferably at greater than or equal to about 7,500,000 CFU/g, and most preferably greater than or equal to about 10,000,000 CFU/g similar to the amount of probiotics found in a serving of yogurt.

As noted above, the probiotics used within the current invention are preferably dehydrated to ensure their shelf stability. The dehydration may occur using any method known in the art that maintains the viability of the probiotics, see Lin Law, C. and Mujumdar, A, Drying: Biological Materials, Encyclopedia of Industrial Biotechnology: Bioprocess, Bioseparation, and Cell Technology, John Wiley & Sons, Inc., 2009; C.A. Morgan et al., Preservation of Micro-Organisms by Drying; A review: Methods, Volume 66, Issue 2, August 2006, Pages 183-193; and C. Santivarangkna et al., Storing Lactic Acid Bacteria: Current Methodologies and Physiological Implications, Food Microbiology and Food Safety, 2011, Part 4, pages 479-504. Preferably, the probiotics are dehydrated using spray drying and/or freeze-drying (lyophilization or cryodesication) and most preferably the probiotics are freeze-dried. Various methodologies for these dehydration processes are known in the art. Id. And U.S. Patent Application No. 2010/0247712 A1.

As noted above, freeze-drying is the preferred process for maintaining the probiotics in a suspended state of animation. However, probiotic strains vary in their susceptibility to freeze-drying. Reasons for this include differences in the surface areas of the microorganisms, and variations in cell wall and membrane composition. During the processing and storage of freeze-dried probiotics oxygen content, high temperature, low pH, water activity and elevated solute concentration may all affect the viability of probiotic organisms (Carvalho et al., 2004). The viability of freeze-dried probiotics within the confections of the current invention may be maintained through one or more of the following factors, including, but not limited to, (1) the use of cryoprotectants during freeze drying, in optimal combinations for each specific bacterial strain, (2) the inclusion of prebiotics, (3) the complete encapsulation by fat base of the present invention, protecting the dry cultures from moisture and oxygen, and (4) the acidic nature of the intimately incorporated components.

Cryogenic protectants are one or more substances which protect cells membranes against the effects of exposure to low temperature and thereby increase the viability of a freeze-dried probiotic. Cryogenic protectants useful in the current invention may include, but are not limited to, polyols (glycerine, propylene glycol, mannitol, sorbitol, xylitol, erythritol, threitol, adonitol, etc.), polysaccharides (raffinose, etc.), disaccharides (trehalose, maltose, sucrose, lactose, etc.), amino acids (proline, etc.), proteins (peptones, milk proteins, etc.), minerals, salts of organic acids, vitamin complex media, methanol, betaine, gelatin, skimmed milk, bovine albumin, sodium glutamate, sodium tripolyphosphate, dextran, and/or combinations thereof. Additionally, commercially available cryoprotectants such as Unipectine™ or Satialgine™ (Degussa Texturant Systems, Newbery Berkshire, UK) may be used as well. In particular, it has been noted that the types and amounts of cryoprotecting agents should be tailored to the probiotic to be freeze-dried. See Khoramnia. A, et al., Enhancement of Viability of a Probiotic Lactobacillus strain for poultry during freeze-drying and storage using the response surface methodology, Animal Science Journal, Vol. 82, Issue 1, Pages 127-135, February 2011. For example, it has been found that 8% skim milk, 22% sucrose and 0.5% lactose is the optimal combination for strains of Lactobacillus brevis, whereas 19.5% skim milk, 1% sucrose, and 9% lactose was optimal for strains of Lactobacillus reuteri. Id. Glycerine has also been shown to enhance the survival of freeze-dried probiotics when stored at room temperature. See Savini, M. et al., Pilot-Scale Production and Viability Analysis of Freeze-Dried Probiotic Bacteria Using Different Protective Agents, Nutrients, 2010, 2, 330-339. The cryoprotectant of the included probiotics will preferably be executed with amounts of cryoprotectants optimal for the specific strain included in the confection of the current invention, and preferably will include at least skim milk, sucrose, lactose, and/or sugar alcohols, such as glycerine. Further, the cryoprotectants preferably do not impart any flavors to the probiotic that would impair the fruit flavor impression of the present confection.

Additionally, prebiotics, a nondigestible food ingredient that is used as an energy source by probiotics, may also be added to the probiotics to provide some protection against the stresses of freeze-drying as well as nutrients to help establish the probiotics within the host. Suitable prebiotics may include, but are not limited to, lactulose, inulin, fructo-oligosaccharides (FOS), galacto oligosaccharides (GOS), transgalacto oligosaccharides, polydextrose, soybean oligosaccharides, isomalto-oligosaccharides, gluco-oligosaccharides, xylo-oligosaccharides, palatinose, gentio-oligosaccharides, resistant starches (Maize starch, etc.), and combinations thereof. Of the prebiotics, the Oligofructose-Enriched Inulin (OEI), or blends of short-chain and long-chain prebiotic saccharides, would be the preferred prebiotic additives allowing for full spectrum molecular link lengths to nourish bacteria throughout the colon. Further, it may be possible to encapsulate the probiotics within the prebiotics to enhance their survival. See Babu, G. et al., Probiotic Viability of Freeze Dried Synbiotic Microcapsules in Skim Milk Powder at Ambient Storage Condition, Internet Journal of Food Safety, Vol. 13, 2011, p. 62-68. In yet a further embodiment of the current invention, the prebiotics may be incorporated into the confection in the absence of probiotics as well.

Furthermore, the fruit flavored chocolates of the current invention are acidic in nature, i.e., having a greater acidity than a chocolate of a similar type would exhibit. Although, the acidity is largely for the purposes of maintaining a vibrant flavor profile it provides the additional benefit of bolstering the viability of the contained probiotics in a product that does not require refrigeration during its normal shelf life.

Ideally, the dehydration and protection methods noted above will work additively or synergistically to maintain the viability of the probiotics within the current confection without freezing, more preferably without the need for refrigeration, and most preferably at room temperature for the useful life of the confection, i.e., until the confection is consumed or expired.

Emulsifiers may also be added as necessary for optimum mouth feel and palatability. Suitable emulsifiers include, but are not limited to, lecithins such as those derived from soya, rape or sunflower seeds, fractionated lecithins, polyglycerol polyricinoleate, ammonium phosphatide (emulsifier YN), citric acid esters such as PALSGAARD Citrem 4201 (Palsgaard A/S, Julesmind, Germany), polyglycol olyricinoleate, sorbitan tristearate, sucrose esters, and/or combinations thereof. The total amount of emulsifiers is less than or equal to about 2% by weight of the resulting confection, preferably is less than or equal to 1.75% by weight of the resulting confection, and most preferably less than or equal to about 1.5% by weight of the resulting confection.

Compounds, which are active in nutritional physiology (nutraceuticals), preferably those known to increase energy, may also be added to the confection of the current invention. Additionally, a preferred embodiment would further include any nutraceuticals—essential nutrients (including vitamins [specifically B-vitamins], minerals, biogenic amines [including tuarine, 1-carnitine], etc.), and/or natural/naturally-derived compounds (including but not limited to stimulants such as caffeine, guarana extractives, theobromine, theophylline, quercetin, ginseng extractives, methylxanthine, etc.) which are active in nutritional physiology and would be specifically included in amounts sufficient to provide for energy inducement and enhancement qualities.

Additionally, a further embodiment of the present invention would utilize the confections of the current invention as a vehicle to aid in the delivery of compounds to the consumer to address nutrient deficiencies, physical ailments, dysfunctions, maladies and/or diseases. Such intimately incorporated compounds may include, but are not limited to, ingestible and lipid-soluble essential nutrients, medicaments, formulations, naturally-derived drugs or FDA approved pharmaceuticals. The inclusion of such additional components are of a percentage consistent with RDA values and/or dosages as set forth by the FDA per serving or suggested dosages for FDA approved pharmaceuticals, if any.

Further, known colorants safe and suitable for use within the confection industry may be used to impart color to the confection of the current invention, which in certain embodiments may approximate the color of the fruit that imparts the flavor to the confection.

Culinary botanical components may be intimately incorporated into the product as either a health benefit or to complement the flavor impression of the source fruit(s) of the current invention. Such botanical components may include, but are not limited to, extractives of vanilla; spice, herbal and root extractives (i.e. beet, ginger, licorice, birch); ground spices; ground herbs; ground nuts; ground coffee; essential oils; cold-pressed citrus oils; powdered stevia (rebiana) extract; green tea powder; black tea powder; malted cereal extracts; dried wine, bee pollen, chlorophyll, kola, yerba mate, guarana extractives, grass/sprout extractives, ground nuts or seeds, nut or seed extractives, powdered flowers, floral essences, and/or combinations thereof. Moreover, these elements, if present, are preferably present in amounts that provide for an additive, cumulative or synergistic flavor/health benefit to the confection; such components acting to complement the flavor impression of the source fruit(s) of the current invention.

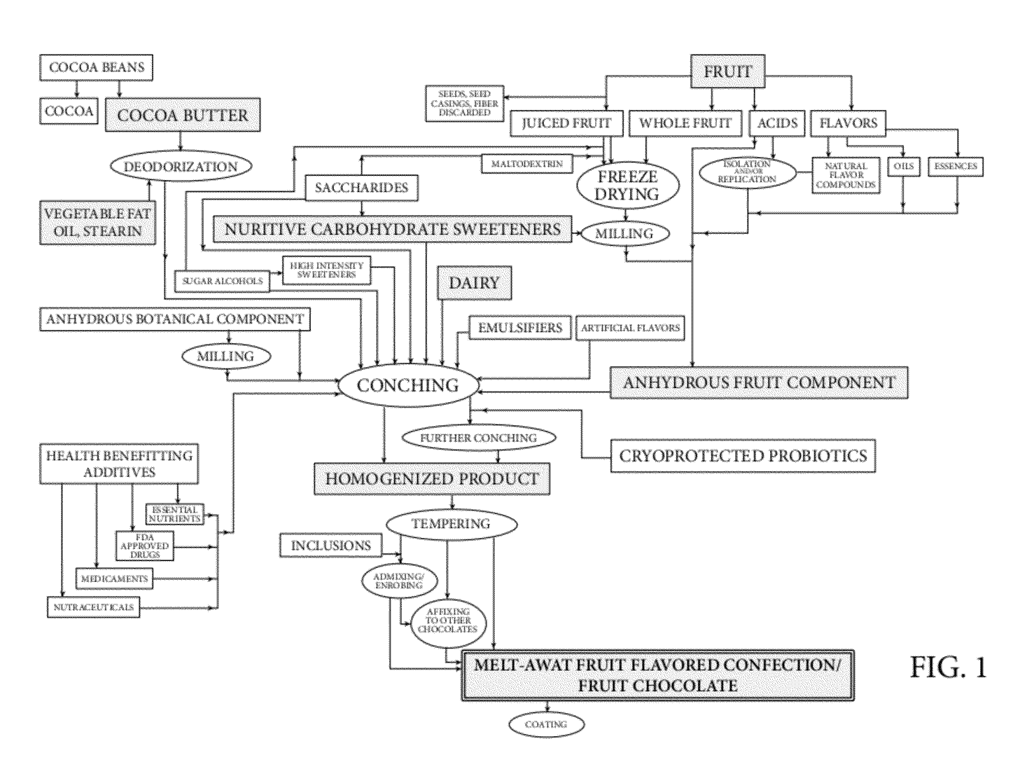

Additionally, saccharides including those derived from crystallized honey, turbinado sugar, dried agave cactus syrup, maple syrup crystals, dried brown rice syrup, corn sugars, caramelized sugar, sorghum syrup crystals, birch syrup crystals, dried barley malt syrup, palm sugar, arenga sugar, coconut sugar may be added. Further, any saccharide present in food or essential in food technology may be added. See Piotr Tomasik, Chemical and Functional Properties of Food Saccharides, CRC Press, 2004, Fig. 1.4. Additionally, a preferred embodiment would further include sucralose, a chlorinated disaccharide.

Sugar alcohols, such as lactitol, sorbitol, maltitol, mannitol, erythritol, threitol, adonitol etc., may also be added as a sweetener in reduced caloric variants of the present invention while retaining the bulk and textural characteristics of full-sugar variants. In particular, the sugar alcohols may be used in conjunction with hyper-sweet sweeteners such as stevia, saccharine, aspartame, etc. to add bulk to those sweeteners. Less preferably, a sugar alcohol with a perceived cooling effect, in particular xylitol is used. In certain embodiments, the chocolate composition may be adjusted to mitigate the perceived cooling effect, and in a further embodiment those sugar alcohols with a perceived cooling effect are excluded altogether.

Additionally, though in lesser preferred embodiments, preservatives typically used in food applications involving the use and incorporation of fruit and fruit juices and/or the manufacture of confections may be employed to retard oxidation of the confection and/or its fruit based component and prevent spoilage. Suitable preservatives may include, but are not limited to, potassium metabisulphite, butylated hydroxyanisol, potassium sorbate, hexanedioic acid, ascorbic acid, benzoic acid, sodium benzoate, butylated hydroxytoluene, calcium propionate, citric acid, ethylenediammine tetracetic acid (EDTA), propyl gallate, or tocopherols. Preferably, the acidity of the confection is high enough to obviate the need for a spoilage agent, and preferably an antioxidant, such as tocopherol, is the sole preservative used.

Additionally, cocoa products other than cocoa butter, such as raw cocoa powder, dutched cocoa powder, and/or chocolate liquor, may be added to the confections of the current invention. However, the additional cocoa products should be present in forms and amounts that do not detract from the current confections predominant or primary fruit flavor impression.

The particle size of the included solids components is generally less than 15 μm; with an ideal size<2 μm. Alternatively, the particles of the solid components may have a D⁵⁰ less than or equal to about 15 μm, preferable less than or equal to about 10 μm, more preferably less than or equal to about 5 μm, and most preferably less than or equal to about 2 μm. More preferably, the particles within the powder exhibit a D⁹⁰ of less than or equal to about 15 μm, preferable less than or equal to about 10 μm, more preferably less than or equal to about 5 μm, and most preferably less than or equal to about 2 μm. The reduction of such particle sizes are a result of either milling or the conching process.

In other preferred embodiments, inclusions such as nuts, ground nuts, dried fruit, freeze-dried fruit, candied fruit, candied ginger, cocoa nibs, wafers, cookies, pretzels, biscuits, crisped/puffed grains, encapsulated liquids, candy pieces, (including gasified candy, nougats, toffees, taffys, brittles, marshmallows, gummies, jellies, etc.) may be admixed to, or otherwise enveloped by, the product prior to the molding of, or the enrobing by, the current confectionary product before the product sets from a plastic to semi-plastic state, through means known to those in the art of confection making.

In an alternative embodiment there is incorporated into the product gasified candy inclusions—candy that has been prepared in its molten state in the presence of pressurized gas, so that when cooled and allowed to harden the resulting candy will have included therein bubbles of pressurized gas as disclosed in U.S. Pat. No. 4,289,794, incorporated herein in its entirety by reference. The gas is then released when the walls of the hard candy encasing the pressurized gas is weakened. Further, the incorporation through admixture of gasified candy would change the texture and mouth feel, as well as the consumer experience, when the current product in such variations is consumed, by introducing a carbonation effect to the fruit flavored confection.

Encapsulated liquids, typically flavor enhanced lipophilic core materials inside a seamless gelatin or alginate shell, may also be admixed prior to the setting of the product from a plastic to a semi-plastic state. U.S. Pat. Application #20080317824, hereby incorporated by reference in its entirety, describes a method for making chocolate coated spherical liquid filled microcapsules with a gelatin/plasticizer or alginate/plasticizer seamless shell.

Preferred embodiments may incorporate the inclusion of encapsulated liquids; such encapsulations are prepared by drip method—a process by which a seamless gelatin or alginate shell surrounding a core liquid is obtained by simultaneously pumping through a concentric multi-component nozzle the core material, which is preferably lipophilic (and thus hydrophobic), and a gelatin/alginate aqueous solution (shell material) so that droplets drip into a lipophilic cooling liquid, thereby hardening the shell.

In another preferred embodiment the chocolate confection is molded into a shape that has an internal reservoir. The reservoir may contain various pates, creams, jellies, syrups, or similar items typically encased within chocolate confections. In a particular embodiment, the chocolate confection may encase, or contain within the reservoir, syrup with an alcohol content less than 10%. Such an embodiment is a means for providing a confection whose flavor profiles mimic those found in alcoholic beverages, i.e. strawberry margarita, Pina Colada, etc. After the filing has been loaded into the reservoir through an injection into the chocolate or an opening within the molded chocolate the reservoir is closed by means known in the art such as a chocolate cap or reheating the area of the confection so that the melted chocolate seals the opening or injection site.

Still another preferred embodiment would include the product coated in a sugar and/or sugar-alcohol based candy shell, confectioners glaze or wax, to prevent the chocolate from melting in the hands of the consumer. Such coatings may be employed to aid in the preservation of the current confection. Further, such coatings may be employed to provide initial flavor impressions.

Other preferred embodiments would be the product as a component to another product, such as a baking chip or coating.

Other preferred embodiments would be the product as a component in a product that includes other forms of ‘chocolates’ as described in the U.S. Code of Federal Regulations, Title 21, Chapter 1, Part 163—COCOA PRODUCTS—Subpart B, such as layers of fruit chocolate affixed to a ‘milk chocolate’ layer or a ‘white chocolate’ layer by the interlacing matrix of cocoa butter crystals that form when these layers set from a plastic stage to a semi-plastic stage.

Manufacture

The fat base of the present invention is a suitable confectionary fat which emulates the principal fat constituent of ‘chocolate’. It follows that the manufacture of the product, in keeping with the present invention, will utilize conventional chocolate making processes and apparatus as disclosed within industry treatises such as: Industrial Chocolate Manufacture and Use, 3d Ed., S.T. Beckett, ed., 1999; Bernard W. Minifie, Chocolate, Cocoa, and Confectionery, 3d ed., Aspen Publishers, Inc., 1999; and Emmanuel Ohene Afoakwa, Chocolate Science and Technology, John Wiley and Sons, 2010. Particularly, the manufacturing process will emulate the manufacturing process of other various kinds of chocolate, by varying the amount of sugar and milk products, in conjunction with the powdered anhydrous fruit components and other ingredients that may be employed in the manufacture of the current invention. The preparation of the present confection follows essentially the same preparation steps as the preparation of conventional chocolate as well as similar confections using confectionary fats. That is to say the usual chocolate making steps, particularly after the separation of cocoa butter from the cocoa liquor, including the conching process are employed.

The manufacture of the current confection may include an intense conching process to assure complete incorporation, but also to further reduce particle size, measured in terms of microns, of the various powdered ingredients to no more than about 15 μm. This particle size is smaller than the tongue can detect, resulting in the state of the product being both homogenous and smooth. The longer the conching process continues the smoother the end product becomes. Preferably, the powdered ingredients are reduced to particles less than or equal to about 10 μm, more preferably less than or equal to about 5 μm, and most preferably less than or equal to about 2 μm. More preferably, the particles within the powdered ingredients are reduced to a D⁵⁰ of less than or equal to about 15 μm, preferable less than or equal to about 10 μm, more preferably less than or equal to about 5 μm, and most preferably less than or equal to about 2 μm. Most preferably, the particles of the powdered ingredients are reduced to a D⁹⁰ of less than or equal to about 15 μm, preferable less than or equal to about 10 μm, more preferably less than or equal to about 5 μm, and most preferably less than or equal to about 2 μm.

The probiotics are added at the end of the conching process in order to ensure minimal structural damage is sustained by the dried colonies, maintaining the viability of these live, though suspended in animation, organisms.

The final step, tempering, is employed. The crystallization of the cocoa butter is controlled by temperature in order to create conditions suitable for the most stable form, which occurs at about 34° C.

The chocolate is first heated to 45° C. (115° F.) to melt all six forms of crystals. It is then cooled to about 27° C. (80° F.), which allows only crystal types IV (also referred to as β′ and V (also referred to as β) to form. At this temperature, the chocolate is agitated to create many small crystals which will serve as “seeds” to create small crystals in the chocolate. The chocolate is then heated to about 31° C. (88° F.) to eliminate any type IV crystals, leaving just type V.

In a preferred embodiment the confection is a stand-alone product; a unique fat-based melt-away confection/chocolate, as in a traditional candy bar or bon bon, highlighting individual and popular fruit flavors. It may additionally be used in manners consistent with chocolate candy making, which would be familiar to those skilled in the art.

All references including patent applications and publications cited herein are incorporated herein by reference in their entirety and for all purpose to the same extent as if each individual publication or patent or patent application was specifically and individually indicated to be incorporated by reference in its entirety for all purposes. Many modifications and variations of this invention can be made without departing from its spirit and scope, as will be apparent to those skilled in the art. The specific embodiments described herein are offered by way of example only, and the invention is to be limited only by the terms of the appended claims, along with the full scope of equivalents to which such claims are entitled.

1. A melt-away fruit-flavored confection prepared in the absence of cocoa solids having a pH comprised of:
(a) an anhydrous component of at least one fruit wherein the fruit of the anhydrous component has a pH in its natural ripened state;
(b) a sweetener;
(c) a suitable confectionary fat; and
(d) dairy;
wherein the pH of the fruit-chocolate is less than 5.75.

2. The melt-away fruit-flavored confection of claim 1, wherein the pH of the confection product is no less than about 3.

3. The melt-away fruit-flavored confection of claim 1, wherein the pH of the confection product is within ±1.5 pH units of the pH of one of the fruits contained within the anhydrous component in its natural ripened state.

4. The melt-away fruit-flavored confection of claim 3, wherein the pH of the confection product is within ±0.75 of the pH of one of the fruits contained within the anhydrous component in its natural ripened state.

5. The melt-away fruit-flavored confection of claim 4, wherein the pH of the confection product is the same as the pH of one of the fruits contained within the anhydrous component in its natural ripened state.

6. The melt-away fruit-flavored confection of claim 1, wherein said fruit of the anhydrous component is comprised of whole fruit; or juiced fruit.

7. The melt-away fruit-flavored confection of claim 6, wherein said fruit of the anhydrous component is further comprised of fruit-based acids or flavorings.

8. The melt-away fruit-flavored confection of claim 1, wherein the confection product is further comprised of a fruit-based acid.

9. The melt-away fruit-flavored confection of claim 1, wherein said fruit based component is any of the known culinary fruits.

10. The melt-away fruit-flavored confection of claim 7, wherein the fruit-based acids or flavorings are comprised of natural or replicated nature identical compounds thereof.

11. The melt-away fruit-flavored confection of claim 10, wherein the natural flavors are comprised of fruit oils or fruit essences

12. The melt-away fruit-flavored confection of claim 1, wherein said fruit is rendered anhydrous through freeze-drying.

13. The melt-away fruit-flavored confection of claim 1, wherein the anhydrous fruit based component has a particle size less than about 50 μm.

14. The melt-away fruit-flavored confection of claim 13, wherein the anhydrous fruit based component has a particle size of about 15 μm.

15. The melt-away fruit-flavored confection of claim 14, wherein the particle size is less than about 2 μm.

16. The melt-away fruit-flavored confection of claim 1, wherein it contains less than about 40 weight percent of the anhydrous fruit based component.

17. The melt-away fruit-flavored confection of claim 1, wherein the dairy component is milk, dry whole milk, concentrated, evaporated, condensed or powdered milk/nonfat milk, milk fat, cream, butter, malted milk, buttermilk, dried buttermilk, concentrated buttermilk, dried cultured milk, whey, whey products or combination thereof.

18. The melt-away fruit-flavored confection of claim 1, further comprised of botanical elements, saccharides, or sugar alcohols.

19. The melt-away fruit-flavored confection of claim 18, wherein the botanicals are an anhydrous plant-based culinary additive derived from vanilla bean, spice extracts, herbal extracts, ground herbs, ground spices, root extracts, powdered stevia extract, green tea powder, black tea powder, bee pollen, rhubarb, powdered soymilk, chlorophyll, freeze dried beet juice, malted cereal extracts, freeze dried wine, coffee, kola, yerba mate, guarana extractives, freeze dried grass and sprout extracts, ground nuts or seeds, nut or seed extracts, powdered flowers, floral essences, essential oils and/or mixtures thereof.

20. The melt-away fruit-flavored confection of claim 18, wherein the saccharide is any saccharide, oligosaccharide, or polysachaccharide present in food or essential in food technology; a chlorinated disaccharide (sucralose); an anhydrous saccharide derived from crystallized honey, turbinado sugar, dried agave cactus syrup, maple syrup crystals, dried brown rice syrup, caramelized sugar, corn sugars, sorghum syrup crystals, birch syrup crystals, dried barley malt syrup, palm sugar, arenga sugar, coconut sugar; or combinations thereof.

21. The melt-away fruit-flavored confection of claim 1, further comprised of cryoprotected probiotics.

22. The melt-away fruit-flavored confection of claim 21, wherein the probiotic is Lactobacilli, Bifidobacteria, Streptococci, Pediococci, Leuconostoc, propionic and acetic bacteria.

23. The melt-away fruit-flavored confection of claim 21, wherein the confection product has a shelf life and at least about 100 million colony forming units of the cryoprotected probiotic per gram of the confection product remain viable throughout the shelf life of the confection product.

24. The melt-away fruit-flavored confection of claim 21, wherein the probiotic cultures are cryoprotected through freeze-drying in the presence of skim milk, sucrose, lactose or sugar alcohols.

25. The melt-away fruit-flavored confection of claim 1, further comprised of essential nutrients, anhydrous medicinal formulations, naturally derived metabolic compounds, or federally approved pharmaceuticals.

26. The melt-away fruit-flavored confection of claim 1, further comprised of preservatives.

27. A method of manufacturing a melt-away fruit-flavored confection of claim 1, wherein
(a) the fruit is freeze-dried in the presence of a saccharide or sugar alcohol; and
(b) the pH of the fruit-chocolate is adjusted to within about ±1.5 of the fruits contained therein in their natural ripened state through the addition of fruit based acids.

28. The method of claim 27, wherein the saccharide is a low-DE maltodextrin.

29. The melt-away fruit-flavored confection of claim 1, wherein the particle size of the anhydrous fruit based component has a D⁹⁰ less or equal to about 15 μm.

30. The melt-away fruit-flavored confection of claim 1, wherein the suitable confectionary fat is a vegetable derived fat, oil, stearin, or combination thereof.

31. The melt-away fruit-flavored confection of claim 30, wherein the vegetable derived fat is cocoa butter, shea butter; mowra butter; kokum butter; illipe butter; Borneo tallow, or combinations thereof.

32. The melt-away fruit-flavored confection of claim 30, wherein the vegetable derived oil is partially hydrogenated palm kernel oil, partially hydrogenated coconut oil, partially hydrogenated palm oil; fractionated palm kernel oil, fractionated palm oil, fractionated coconut oil, fractionated corn oil, fractionated peanut oil, fractionated soy oil, fractionated cottonseed oil, fractionated sunflower oil, fractionated safflower oil, or combinations thereof.

33. The melt-away fruit-flavored confection of claim 31, wherein the vegetable derived fat is cocoa butter.

34. The melt-away fruit-flavored confection of claim 1, further comprising an emulsifying agent.

35. The melt-away fruit-flavored confection of claim 34, wherein the total amount of the emulsifying agent does not exceed about 2 percent by weight of the fruit flavored confection.

36. The melt-away fruit-flavored confection of claim 1, which further comprises raw cocoa powder, dutched cocoa powder, chocolate liquor.

37. The melt-away fruit-flavored confection of claim 1, wherein the sweetener is a nutritive sweetener.

38. The melt-away fruit-flavored confection of claim 1, wherein the sweetener is a non-nutritive sweetener.

39. The melt-away fruit-flavored confection of claim 1, further comprised of an artificial flavoring.
